(19) United States
(12) Patent Application Publication
(10) Pub. No.: US 2010/0164860 A1
(43) Pub. Date: Jul. 1, 2010

(54) LIQUID CRYSTAL DISPLAY DEVICE

(75) Inventor: Kenji Misono, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/663,005

(22) PCT Filed: May 27, 2008
(86) PCT No.: PCT/JP2008/001317

§ 371 Date: Dec. 4, 2009

(30) Foreign Application Priority Data
Jun. 6, 2007 (JP) 2007-150657

(51) Int. Cl. G09G 3/36

(52) U.S. Cl. 345/102

(57) ABSTRACT

A liquid crystal display device (100A) includes: a backlight (30a) with a curved emitting surface; and an LCD panel (10a), of which the surface that receives light emitted from the backlight and the surface that transmits light to conduct a display operation both have substantially the same degree of curvature as the emitting surface of the backlight. Supposing a plane that includes four points on two opposing ones of the four sides that define the extension of the emitting surface (32a) of the backlight is a reference plane (RPa), the light emitted through the emitting surface has an intensity distribution that has a half-width angle of ±30 degrees or less with respect to a normal to the reference plane.

### TECHNICAL FIELD

The present invention relates to a liquid crystal display device and more particularly relates to a direct-view liquid crystal display device.

### BACKGROUND ART

Recently, LCDs with a curved display panel have been developed. As disclosed in Patent Documents Nos. 1 and 2, for example, an LCD with a curved panel is generally obtained by simply bending a flat LCD panel.
Patent Document No. 1: Japanese Patent Application Laid-Open Publication No. 11-38395
Patent Document No. 2: Japanese Patent Application Laid-Open Publication No. 2004-29487

### DISCLOSURE OF INVENTION

### Problems to be Solved by the Invention

According to the results of experiments the present inventors carried out, however, if a flat LCD panel is simply bent, then the viewing angle characteristic thereof will deteriorate. Also, if a flat backlight is bent as much as the flat LCD panel, the light emitted from the curved emitting surface toward the LCD panel will have its intensity distribution broadened so much that the display quality will also deteriorate.

It is therefore an object of the present invention to provide a liquid crystal display device with a curved display panel that will achieve high display quality by overcoming at least one of these problems with the related art.

### Means for Solving the Problems

A liquid crystal display device according to the present invention includes: a backlight with a curved emitting surface; and an LCD panel, of which the surface that receives light emitted from the backlight and the surface that transmits light to conduct a display operation both have substantially the same degree of curvature as the emitting surface of the backlight. Supposing a plane that includes four points on two opposing ones of the four sides that define the extension of the emitting surface of the backlight is a reference plane, the light emitted through the emitting surface has an intensity distribution that has a half-width angle of ±30 degrees or less with respect to a normal to the reference plane.

In one preferred embodiment, the LCD panel includes two substrates and a liquid crystal layer interposed between the substrates, and the surface of each said substrate that contacts with the liquid crystal layer includes multiple planes that are parallel to the reference plane.

In this particular preferred embodiment, the multiple planes that form that surface of each said substrate that contacts with the liquid crystal layer are defined by the upper surface of a stair structure.

In a specific preferred embodiment, the step pitch of the stair structure is an integral number of times as wide as a pixel pitch. Optionally, the stair pitch may be equal to the pixel pitch.

In still another preferred embodiment, the stair structure is made of a material for an alignment film.

In yet another preferred embodiment, the emitting surface is arched along the vertical direction of the display screen of the LCD panel.

In this particular preferred embodiment, if the curved surfaces have a radius of curvature R, the LCD panel has a pixel pitch L in the length direction, the stair structure has a level difference H, and θ (deg)=90 L/πR, H=2R (sin θ)² is satisfied.

In yet another preferred embodiment, the backlight is an edge light type backlight with a light guide, which has a total reflection prism on the other side of the backlight opposite to the emitting surface.

In yet another preferred embodiment, the LCD panel has two substrates, at least one of which is a plastic substrate.

### Effects of the Invention

In a liquid crystal display device with a curved display panel according to the present invention, the light emitted from a backlight with a curved emitting surface has an intensity distribution, of which the half-width angle has been adjusted to ±30 degrees or less with respect to a normal to the reference plane of an LCD panel, thus realizing a display panel of quality.

### BRIEF DESCRIPTION OF DRAWINGS

FIGS. 1(a) and 1(b) are schematic cross-sectional views illustrating liquid crystal display devices 100A and 100B as preferred embodiments of the present invention.

FIGS. 2(a) and 2(b) are side views schematically illustrating configurations for a backlight 30a for use in the liquid crystal display device 100A of that preferred embodiment of the present invention and a comparative backlight 30a′, respectively.

FIGS. 3(a) and 3(b) are cross-sectional views schematically illustrating configurations for an LCD panel 10a for use in the liquid crystal display device 100A of the preferred embodiment of the present invention and a comparative LCD panel 10a′, respectively.

FIG. 4 is a cross-sectional view schematically illustrating a configuration for a backlight 30A, of which the emitting surface is a raised curved surface and which may be used as the backlight 30a for the liquid crystal display device 100A of the preferred embodiment of the present invention.

FIG. 5 is a cross-sectional view schematically illustrating a configuration for an alternative backlight 30B, of which the emitting surface is a raised curved surface and which may also be used as the backlight 30a for the liquid crystal display device 100A of the preferred embodiment of the present invention.

FIGS. 6(a) and 6(b) are graphs showing the angular distributions of the outgoing light rays emitted through the emitting surface of the backlights 30A and 30B, respectively, while FIGS. 6(c) and 6(d) illustrate coordinate systems that define the measuring directions.

FIG. 7 is a schematic cross-sectional view illustrating an LCD panel 10A, of which the display screen is raised toward the viewer and which may be used as the LCD panel 10a for the liquid crystal display device 100A of the preferred embodiment of the present invention.

FIG. 8A schematically illustrates a correlation between pixels of the LCD panel 10A and the stair structure 23a.

FIG. 8B illustrates how to define the relation between the height H and pitch L of the stair structure 23a shown in FIG. 8A.

FIGS. 9(a), 9(b) and 9(c) are schematic representations illustrating how a stair structure may be formed for the LCD panel 10A by inkjet process (for FIG. 9(a)) and by nano-printing process (for FIGS. 9(b) and 9(c)), respectively.

### DESCRIPTION OF REFERENCE NUMERALS

10a, 10b LCD panel
12a, 12b, 14a, 14b substrate
30a, 30b backlight
32a, 32b emitting surface
100A, 100B liquid crystal display device

### BEST MODE FOR CARRYING OUT THE INVENTION

Hereinafter, preferred embodiments of a liquid crystal display device according to the present invention will be described with reference to the accompanying drawings. However, the present invention is in no way limited to the specific preferred embodiments to be described below.

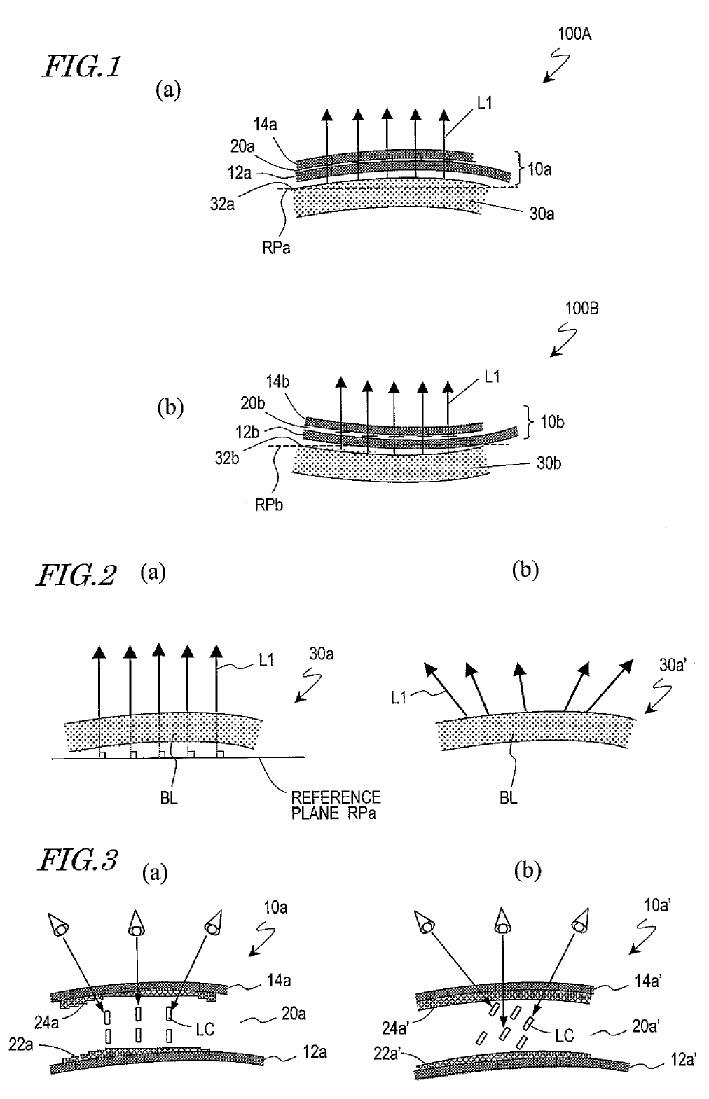

First of all, basic arrangements for liquid crystal display devices 100A and 100B as specific preferred embodiments of the present invention will be described with reference to FIGS. 1(a) and 1(b).

Specifically, the liquid crystal display device 100A shown in FIG. 1(a) has a display panel that is raised toward the viewer (i.e., curved so as to protrude toward the viewer). The liquid crystal display device 100A includes a backlight 30a with a convex curved emitting surface and an LCD panel 10a, of which the surface that receives the light emitted from the backlight 30a and the surface that transmits light to conduct a display operation both have substantially the same degree of curvature as the emitting surface of the backlight. The LCD panel 10a includes substrates 12a and 14a and a liquid crystal layer 20a that is interposed between the substrates 12a and 14a.

In this case, supposing a plane that includes four points on two opposing ones of the four sides that define the extension of the emitting surface 32a of the backlight 30a is a reference plane RPa, the light L1 emitted from the emitting surface has an intensity distribution that has been adjusted so as to have a half-width angle of ±30 degrees or less with respect to a normal to the reference plane RPa. In this example, the reference plane is defined with respect to the emitting surface of the backlight. However, a reference plane may also be defined similarly with respect to the display screen of the LCD panel. Also, in the liquid crystal display device of the present invention, the respective reference planes of the backlight and the LCD panel are arranged substantially parallel to each other. Thus, in the following description, those reference planes will sometimes be simply referred to herein as a “reference plane”.

On the other hand, the liquid crystal display device 100B shown in FIG. 1(b) has a display panel that is depressed with respect to the viewer (i.e., curved so as to protrude in the opposite direction away from the viewer). The liquid crystal display device 100B includes a backlight 30b with a concave curved emitting surface and an LCD panel 10b, of which the surface that receives the light emitted from the backlight 30b and the surface that transmits light to conduct a display operation both have substantially the same degree of curvature as the emitting surface of the backlight. The LCD panel 10b includes substrates 12b and 14b and a liquid crystal layer 20b that is interposed between the substrates 12b and 14b.

In this case, supposing a plane that includes four points on two opposing ones of the four sides that define the extension of the emitting surface 32b of the backlight 30b is a reference plane RPb, the light L1 emitted from the emitting surface has an intensity distribution that has been adjusted so as to have a half-width angle of ±30 degrees or less with respect to a normal to the reference plane RPb.

In these liquid crystal display devices 100A and 100B, the intensity distribution of the light L1 emitted from the backlight 30a or 30b has been adjusted so as to have a half-width angle of ±30 degrees or less with respect to a normal to the reference plane RPa or RPb. As a result, the deterioration in display quality due to non-uniformity in the angle of incidence of the light on the LCD panel 10a or 10b can be minimized.

Next, the feature of the backlight 30a that the liquid crystal display device 100A has will be described with reference to FIGS. 2(a) and 2(b).

FIGS. 2(a) and 2(b) schematically illustrate the configurations of the backlight 30a and a comparative backlight 30a′, respectively. If the light guide of an edge light type backlight were simply bent, then the emitted light would have a broadened distribution as shown in FIG. 2(b). As a result, the liquid crystal layer thereof would have a different effective retardation according to the direction of the emitted light and the display quality would deteriorate. On the other hand, in the liquid crystal display device 100A of this preferred embodiment of the present invention shown in FIG. 2(a), the light emitted from the backlight 30a has an intensity distribution that has been adjusted so as to have a half-width angle of ±30 degrees or less with respect to a normal to the reference plane RPa, and therefore, the deterioration in display quality can be minimized. In this example, the backlight 30a, of which the emitting surface protrudes toward the viewer, has been described. But the same statement applies to the other type of backlight 30b, of which the emitting surface protrudes in the opposite direction away from the viewer, too.

Next, the feature of the LCD panel 10a of the liquid crystal display device 100A will be described with reference to FIGS. 3(a) and 3(b).

FIG. 3(a) schematically illustrates a configuration for the LCD panel 10a, while FIG. 3(b) illustrates a configuration for a comparative LCD panel 10a′. Both of these drawings schematically illustrate how liquid crystal molecules LC will be aligned when a voltage is applied to the liquid crystal layer 20a or 20b made of a nematic liquid crystal material with positive dielectric anisotropy.

If a curved LCD panel 10a′ were fabricated by the technique disclosed in Patent Document No. 1 or 2, for example, the surface of the substrates 12a′ and 14a′ that contacts with the liquid crystal layer 20a′ (which usually has an alignment film) would be a continuous curved surface. That is why the liquid crystal molecules LC would not be aligned along a normal to the reference plane RPa but along a normal to the curved surface. As a result, the display quality would have heavy viewing angle dependence. On the other hand, in the LCD panel 10a of the liquid crystal display device 100A of this preferred embodiment of the present invention shown in FIG. 3(a), the surface of the substrates 12a and 14a that contacts with the liquid crystal layer 20a has multiple planes 22a and 24a that are parallel to the reference plane RPa. That is why the liquid crystal molecules LC would be aligned along a normal to the reference plane RPa upon the application of a voltage, and therefore, the display quality would have little viewing angle dependence. In this example, the LCD panel 10a, of which the display screen protrudes toward the viewer, has been described. But the same statement applies to the other type of LCD panel 10b, of which the display screen protrudes in the opposite direction away from the viewer, too.

As can be seen from the foregoing description, it is preferred that the backlight 30a or 30b and the LCD panel 10a or 10b be used in a right combination because their effects would be achieved so as to multiply each other.

In FIGS. 1(a) and 1(b), the LCD panels 10a and 10b are illustrated as consisting of only two substrates 12a, 14a and 12b, 14b and a liquid crystal layer 20a and 20b interposed between the substrates. Naturally, however, the LCD panels 10a and 10b further include two polarizers and a phase plate, if necessary. The LCD panels 10a and 10b may be TN mode or STN mode LCD panels, for example, but may also be VA mode or IPS mode LCD panels as well.

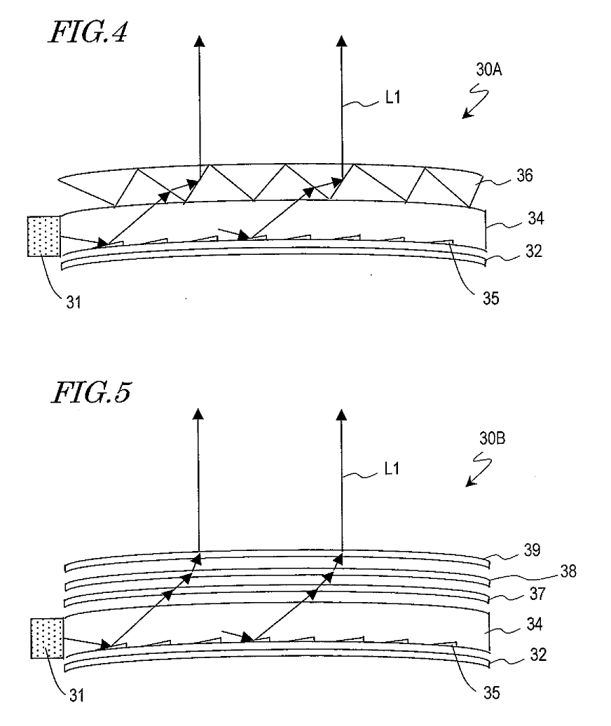

Next, a specific example of a backlight that can be used effectively in a liquid crystal display device as a preferred embodiment of the present invention will be described with reference to FIGS. 4 and 5.

The backlight 30A shown in FIG. 4 has a raised curved emitting surface and may be used as the backlight 30a of the liquid crystal display device 100A shown in FIG. 1.

The backlight 30A is an edge light type backlight including a light source (such as an LED) 31 and a light guide 34. The backlight 30A further includes a reflector 32, which is arranged on the rear side (i.e., opposite to the emitting surface), and an antiprism 36, which is arranged on the emitting surface of the light guide 34. In addition, on the rear side of the light guide 34, arranged is a total reflection prism 35. The light emitted from the light source 31 enters the light guide 34 through a side surface thereof and then propagates through the light guide 34. Part of that light propagating through the light guide 34 is reflected by the total reflection prism 35 to leave the light guide 34 through the emitting surface (i.e., the surface opposed to the LCD panel). Then, the light that has gone out of the light guide 34 is incident on the antiprism 36 (i.e., a prism, of which the ridges are arranged on the light incoming side (or the light outgoing side of the light guide 34 in this example)). Subsequently, the light that has been refracted and totally reflected by the antiprism 36 is directed to leave the antiprism 36 mostly along a normal to the reference plane.

The reflector 32 reflects back the light that has once left the light guide 34 through the rear side thereof toward the light guide 34 again, thereby increasing the optical efficiency of the light produced. To make the in-plane intensity distribution of the light leaving the light guide 34 through the emitting surface thereof as uniform as possible, the arrangement pitch of the total reflection prism 35 and/or the thickness of the light guide 34 are/is preferably adjusted. Specifically, the more distant from the light source 31, the smaller the arrangement pitch of the total reflection prism 35 and/or the thickness of the light guide 34.

Alternatively, the backlight 30B shown in FIG. 5 may also be used instead of the backlight 30A. In FIG. 5, any component that has the same function as the counterpart of the backlight 30A is identified by the same reference numeral and the description thereof will be omitted herein.

The backlight 30B includes a diffusion sheet 37, a first condensing sheet 38 and a second condensing sheet 39, which are stacked in this order on the emitting surface of the light guide 34.

The diffusion sheet 37 functions so as to make the luminance as uniform as possible by diffusing the outgoing light of the light guide 34 in various directions. As the diffusion sheet 37, a transparent resin matrix in which particles with a different refractive index from the resin matrix are dispersed may be used, for example.

The first condensing sheet 38 has the function of aligning the emitting directions in which the light rays that have been transmitted through the diffusion sheet 37 (i.e., diffused light rays) are traveling into a particular direction, which may be either the vertical direction (i.e., 12 o'clock to 6 o'clock direction) or the horizontal direction (i.e., 9 o'clock to 3 o'clock direction) as viewed along a normal to the display screen. As used herein, “to align the emitting directions of the light rays into the vertical direction” means giving such directivity as to limit the horizontal spread of the outgoing light rays (i.e., so that the outgoing light rays will have a narrower angular distribution horizontally). The first condensing sheet 38 is typically a sheet with triangular or wavy prism on the surface. Specifically, BEF (brightness enhancement film) produced by 3M Company is preferably used as the first condensing sheet 38.

The second condensing sheet 39 also basically has the function of aligning the emitting directions of the light rays into a particular direction just like the first condensing sheet 38. However, that particular direction in which the emitting directions are aligned by the second condensing sheet 39 is perpendicular to that of the first condensing sheet 38. That is to say, if the light rays, of which the emitting directions have been aligned by the first condensing sheet 38 into either the vertical direction (i.e., 12 o'clock to 6 o'clock direction) or the horizontal direction (i.e., 9 o'clock to 3 o'clock direction), have their emitting directions further aligned by the second condensing sheet 39 into either the horizontal direction or the vertical direction, the directivity of the outgoing light can be further increased (i.e., the range of the angles of emittance can be narrowed). A BEF produced by 3M Company may also be used as the second condensing sheet 39 but a BEF-RP (brightness enhancement film-reflective polarizer) is more preferably used as the second condensing sheet 39.

A BEF-RP is a composite optical film including a BEF and a polarization reflective film, which is arranged on the light outgoing side of the BEF (i.e., closer to the LCD panel), and can contribute to further increasing the optical efficiency. Specifically, if the polarization transmission axis of the BEF-RP (i.e., the transmission axis of the polarization reflective film) is arranged parallel to the transmission axis of the lower polarizer of the LCD panel (i.e., the polarizer that is arranged so as to face the backlight), the optical efficiency can be increased. For example, if a linearly polarized light ray to be transmitted through the BEF-RP and the lower polarizer of the LCD panel is a P wave, then the polarization reflective film of the BEF-RP would selectively reflect only an S wave toward the light guide 34 and transmit only the P wave. In this case, in the linearly polarized light ray that has been incident on the BEF-RP, the S wave is reflected toward the light guide 34 and only what has been converted into the P wave is transmitted through the BEF-RP. Were it not for the polarization reflective film, the S wave transmitted through the BEF would be absorbed into the lower polarizer of the LCD panel and could not contribute to a display operation. However, by providing such a polarization reflective film, the S wave is reflected until it is converted into a P wave, which will be transmitted through the polarization reflective film and the lower polarizer and contribute to the display operation. As a result, the optical efficiency can be further increased.

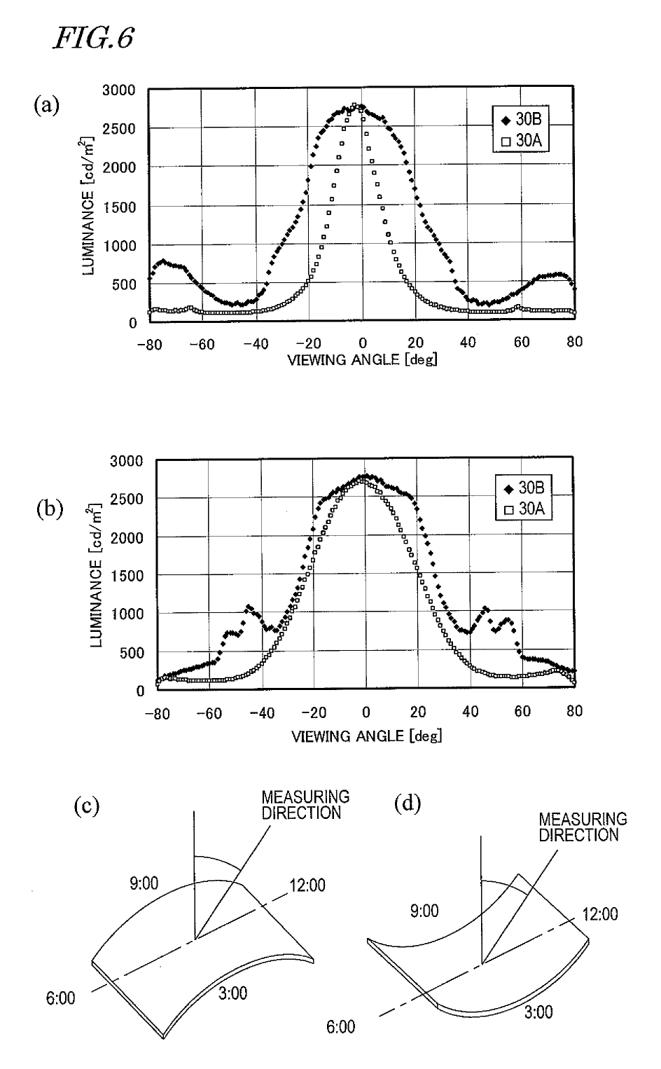

FIGS. 6(a) and 6(b) show the angular distributions of the light rays that left the backlights 30A and 30B through the emitting surface thereof. In this case, the intensity distributions of backlights, of which the emitting surface is bent as a single curved surface as shown in FIG. 6(c), are shown. The rectangular backlights are curved along their longer sides. Supposing the longer side direction defines the 12 o'clock to 6 o'clock direction and the shorter side direction that intersects with the longer side direction at right angles defines the 9 o'clock to 3 o'clock direction, FIG. 6(a) shows the viewing angle (or polar angle) dependence of the intensity (or luminance) of the outgoing light in the 12 o'clock to 6 o'clock direction. And FIG. 6(b) shows the viewing angle (or polar angle) dependence of the intensity (or luminance) of the outgoing light in the 9 o'clock to 3 o'clock direction. In both cases, the viewing angle is supposed to be 0 degrees along a normal to the reference plane. As for each of these two backlights, three 1,000 mcd LEDs are arranged as the light source 31 beside the incident side surface of the light guide 34.

As can be seen from FIGS. 6(a) and 6(b), in each of these backlights 30A and 30B, the intensity distribution of the outgoing light leaving through the emitting surface has a half-width angle of ±30 degrees or less with respect to a normal to the reference plane and has good directivity. It should be noted that the light emitted from the backlight 30B has had its polarization directions aligned, and therefore, maintains the intensity shown in FIG. 6(b) even after having been transmitted through the lower polarizer of the LCD panel. Consequently, the backlight 30B will achieve higher optical efficiency than the backlight 30A.

In this example, the intensity distribution of the outgoing light has been described as for the backlight, of which the curved surface is raised toward the viewer. However, as shown in FIG. 6(d), a similar intensity distribution can be obtained by the same configuration as the backlights 30A and 30B as for the other type of backlight, of which the curved surface is depressed away from the viewer.

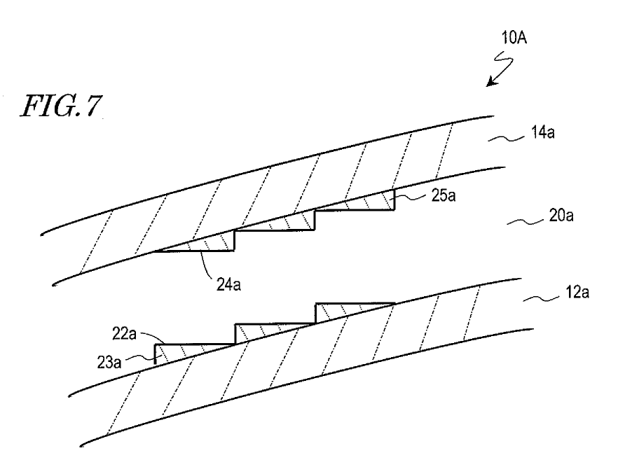

Hereinafter, a specific example of an LCD panel that can be used effectively in a liquid crystal display device as a preferred embodiment of the present invention will be described with reference to FIG. 7.

The LCD panel 10A shown in FIG. 7 has a curved display panel that is raised toward the viewer and that may be used as the LCD panel 10a of the liquid crystal display device 100A shown in FIG. 1.

The LCD panel 10A includes two substrates 12a and 14a and a liquid crystal layer 20a interposed between them. The substrate 12a may be a TFT substrate and the substrate 14a may be a color filter substrate, for example. Although various components required are actually arranged on a glass substrate or a plastic substrate, the illustration of those components is omitted for the sake of simplicity.

As for a liquid crystal display device to be used as a mobile one, plastic substrates are preferably used because such substrates are lightweight and easy to form into any curved shape. A curved substrate or a curved LCD panel may be fabricated by a known process such as the one disclosed in Patent Document No. 1. Examples of preferred materials for the plastic substrate include thermosetting resins such as an epoxy resin and a polyimide resin, photo curable resins such as an acrylic resin, and thermoplastic resins such as polycarbonate and polyethersulfone. Also, to increase the mechanical strength and to decrease the thermal expansivity, the resin is preferably reinforced with inorganic fibers such as glass fibers. In this example, an epoxy fiber reinforced plastic substrate with a thickness of 100 μm was used. More specifically, what was obtained by impregnating glass cloth with a thermosetting resin consisting essentially of an epoxy resin was used. If necessary, the surface of the plastic substrate may be coated with a barrier layer of an inorganic material such as silicon dioxide or silicon nitride. Alternatively, the plastic substrate may be coated with an organic hard coating layer such as an acrylic hard coating layer and then a barrier layer of an inorganic material may be deposited thereon.

The surface of the substrates 12a and 14a that contacts with the liquid crystal layer 20a has multiple planes 22a and 24a that are parallel to the reference plane. Specifically, a stair structure 23a has been formed on the surface of the substrate 12a so as to contact with the liquid crystal layer 20a and the upper surface of each step of the stair structure 23a is a plane 22a that is parallel to the reference plane. Likewise, in the substrate 14a, a stair structure 25a has also been formed on its surface that contacts with the liquid crystal layer 20a and the upper surface of each step of the stair structure 25a is a plane 24a that is parallel to the reference plane. Furthermore, each of the multiple planes 22a of the substrate 12a and an associated one of the planes 24a of the substrate 14a squarely face each other one to one and the thickness of the liquid crystal layer 20a is uniform between every pair of the planes. That is to say, the stair structures 23a and 25a have an equal stair pitch and the same phase, and therefore, the thickness of the liquid crystal layer 20a is uniform perpendicularly to the reference plane.

Thus, as already described with reference to FIG. 3(a), when a voltage is applied to the liquid crystal layer 20a, the liquid crystal molecules are aligned along a normal to the reference plane. As a result, the display quality will have little viewing angle dependence. Also, if the surface of the stair structure that contacts with the liquid crystal layer 20a is made up of multiple planes 22a or 24a that are parallel to the reference plane and side surfaces that cross the reference plane at right angles as in the stair structures 23a and 25a shown in FIG. 7, then the liquid crystal molecules will have their alignment state controlled substantially only by those planes 22a or 24a that are parallel to the reference plane. Consequently, the effects described above will be achieved to the maximum degree. In this example, it has been described what if a voltage is applied to the liquid crystal layer made of a nematic liquid crystal material with positive dielectric anisotropy. However, the same statement applies to the display quality that a vertical aligned (VA) mode liquid crystal display device, including a nematic liquid crystal material with negative dielectric anisotropy and a vertical alignment film in combination, will have when no voltage is applied thereto. That is to say, if the LCD panel 10A shown in FIG. 7 is applied to a VA mode, the viewing angle dependence of black display quality can be reduced.

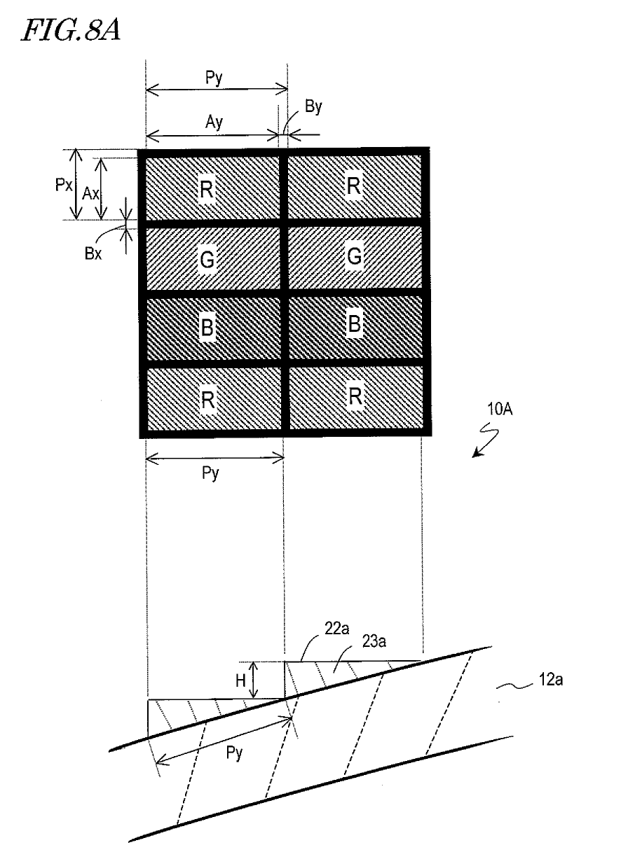

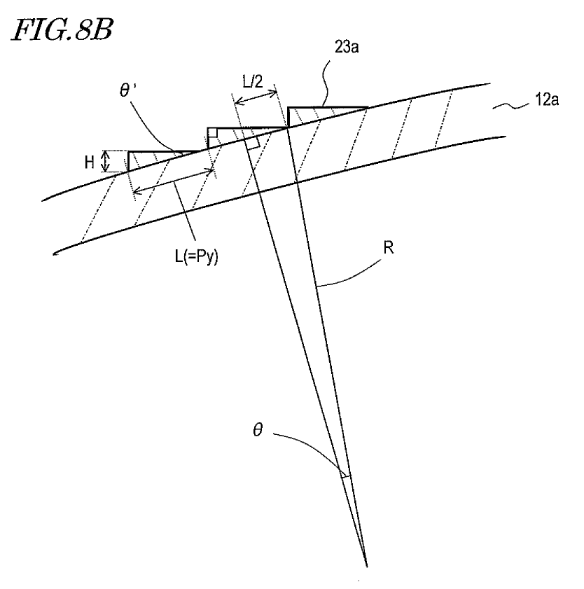

Next, a preferred pitch for the stair structure 23a will be described with reference to FIGS. 8A and 8B. Specifically, FIG. 8A schematically illustrates a correlation between pixels of the LCD panel 10A and the stair structure 23a, while FIG. 8B illustrates how to define the relation between the height H and pitch L of the stair structure 23a. In this case, pixels are arranged in rows (i.e., in x direction) and columns (i.e., in y direction) so as to form a matrix pattern and the display panel is supposed to be have a single curved surface that is bent in the y direction. The plan view illustrated in FIG. 8A is as viewed along a normal to the reference plane. Nevertheless, the lengths Py, Ay and By in the y direction are measured along the curved surface.

In the LCD panel 10A shown in FIG. 8A, the pixels have pitches Px and Py of 75 μm and 215 μm in the x and y directions, respectively. The black matrix between each pair of adjacent pixels has a width Bx, By of 15 μm both in the x and y directions. Each pixel aperture has dimensions Ax and Ay of 60 μm and 200 μm in the x and y directions, respectively. The LCD panel 10A has a screen size of 2 inches diagonally and its pixel arrangement consists of 128×RGB×160 pixels. That is to say, 384 (=128×3) pixels (also called “dots”) are arranged in the row direction (i.e., in the x direction) and 160 pixels (or dots) are arranged in the column direction (i.e., in the y direction).

As shown in FIG. 8A, the stair structure 23a has steps that are arranged in the y direction, the pitch of the stair structure is equal to the pixel pitch Py, and the level difference portions (i.e., the side surfaces that intersect with the reference plane at right angles) are arranged so as to face the black matrix. According to such an arrangement, even if the liquid crystal molecules were misaligned by the level difference portions, the influence on the display quality would be minimized.

Supposing the single curved surface of the LCD panel 10A has a radius of curvature of 200 mm, the level difference H of the stair structure 23a will be 116 μm because the pixel pitch Py in the y direction is 215 μm.

As shown in FIG. 8B, if the LCD panel 10A has a pixel pitch L (=Py in this example), the stair structure has a level difference H, the curved surface of the substrate 12a has a radius of curvature R, an arc with a length of L/2 has a center angle θ (deg) and the angle formed between the stair structure 23a and the curved surface of the substrate 12a (which may be approximated as a tangential line with respect to the curved surface because the curvature is small) is θ′, then H=L sin θ′ and L=2R sin θ are satisfied. As the very small angles θ and θ′ may be regarded as approximately equal to each other, the equation H=2R (sin θ)² can be obtained. In this case, since L=2×2πR×(θ/360), θ=90 L/πR. The level difference H of the stair structure 23a can be calculated by these equations.

In the example described above, the step pitch of the stair structure is supposed to be equal to the pixel pitch. However, although naturally it depends on the required radius of curvature and pixel pitch, the effect described above can also be achieved if the step pitch is an integral number of times as wide as the pixel pitch.

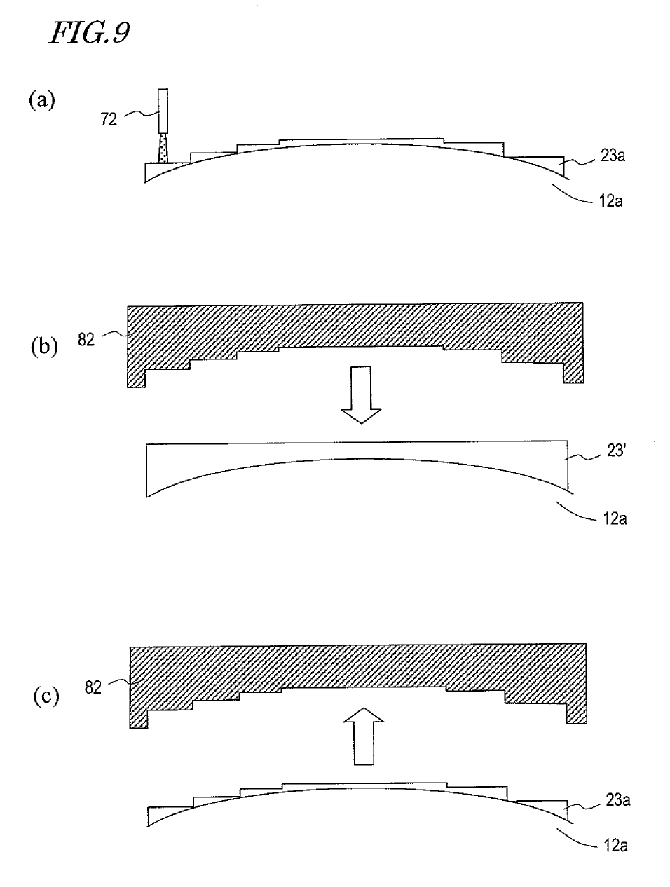

The stair structures 23a and 25a may be formed by inkjet printing using an alignment film material, for example. Specifically, as schematically shown in FIG. 9(a), a predetermined amount of an alignment film material is discharged by moving a nozzle 72 with the substrate 12a bent to have a predetermined curvature, and then gets solidified by heating it as needed, thereby obtaining the stair structure 23a.

Alternatively, as schematically shown in FIGS. 9(b) and 9(c), a nano-printing process may also be adopted. Specifically, an alignment film 23′ is formed on a substrate 12a that has been bent to have a predetermined curvature, and then a die 82 with a predetermined shape that has been prepared in advance to make a stair structure is pressed against the alignment film 23′, thereby patterning the alignment film 23′ into the shape of the stair structure 23a. And then the die is removed and the alignment film material gets solidified by heating it, if necessary. In this manner, the stair structure 23a can also be obtained.

In the LCD panel, its surface that contacts with the liquid crystal layer needs to be covered with an alignment film. Optionally, an undercoat layer may be formed so as to have the stepped surface shape of the stair structure, and an alignment film may be deposited so as to cover the undercoat layer. The undercoat layer may be made of a photosensitive resin, for example. In that case, an electrode (of an ITO layer) is preferably formed on the undercoat layer that has the stepped surface shape of the stair structure, and then an alignment film is preferably deposited so as to cover the electrode. By adopting such a structure, the electrode can be arranged parallel to the reference plane. That is why the electric field applied to the liquid crystal layer becomes parallel to a normal to the reference plane and the alignment state of the liquid crystal molecules can be further stabilized. On top of that, according to such a structure, no voltage drop would be caused by the stair structure.

### INDUSTRIAL APPLICABILITY

A liquid crystal display device according to the present invention can be used effectively as a display device for cellphones and various other mobile electronic devices.

1. A liquid crystal display device comprising:
a backlight with a curved emitting surface; and
an LCD panel, of which the surface that receives light emitted from the backlight and the surface that transmits light to conduct a display operation both have substantially the same degree of curvature as the emitting surface of the backlight,
wherein supposing a plane that includes four points on two opposing ones of the four sides that define the extension of the emitting surface of the backlight is a reference plane, the light emitted through the emitting surface has an intensity distribution that has a half-width angle of ±30 degrees or less with respect to a normal to the reference plane.

2. The liquid crystal display device of claim 1, wherein the LCD panel includes two substrates and a liquid crystal layer interposed between the substrates, and wherein the surface of each said substrate that contacts with the liquid crystal layer includes multiple planes that are parallel to the reference plane.

3. The liquid crystal display device of claim 2, wherein the multiple planes that form that surface of each said substrate that contacts with the liquid crystal layer are defined by the upper surface of a stair structure.

4. The liquid crystal display device of claim 3, wherein the step pitch of the stair structure is an integral number of times as wide as a pixel pitch.

5. The liquid crystal display device of claim 3, wherein the stair structure is made of a material for an alignment film.

6. The liquid crystal display device of claim 5, wherein the emitting surface is arched along the vertical direction of the display screen of the LCD panel.

7. The liquid crystal display device of claim 6, wherein if the curved surfaces have a radius of curvature R, the LCD panel has a pixel pitch L in the length direction, the stair structure has a level difference H, and θ (deg)=90 L/πR, then H=2R (sin θ)² is satisfied.

8. The liquid crystal display device of claim 1, wherein the backlight is an edge light type backlight with a light guide, the light guide having a total reflection prism on the other side of the backlight opposite to the emitting surface.

9. The liquid crystal display device of claim 1, wherein the LCD panel has two substrates, at least one of which is a plastic substrate.
